(19) United States
(12) Patent Application Publication
(10) Pub. No.: US 2002/0095297 A1
(43) Pub. Date: Jul. 18, 2002

(54) Device and method for processing audio information

(76) Inventor: Satoshi Hasegawa, Tokyo (JP)

Correspondence Address: Steven I Weisburd Esq, Dickstein Shapiro Morin & Oshinsky LLP, 1177 Avenue of the Americas 41st Floor, New York, NY, 10036-2714, US

(21) Appl. No.: 10/046,719

(22) Filed: Jan. 17, 2002

(30) Foreign Application Priority Data
Jan. 17, 2001 (JP) 009564/2001

(51) Int. Cl. G10L 21/00

(52) U.S. Cl. 704/500

(57) ABSTRACT

There is provided a device wherein a scaling section calculates a scaling factor, which indicates a multiplying power to a reference value, of each of the subbands that are audio information divided into a plurality of frequency bands to align each dynamic range, and an outputted signal from the scaling section is coded by a MPEG system, comprising a signal level calculating section and a feature detection processing section. The signal level calculating section calculates a signal level using a scaling factor of each of the subbands from the scaling section. The feature detection processing section, after finding a maximum value and a minimum value of the calculated signal levels, calculates a difference therebetween, determines an interval to be a voice signal when the difference value is greater than or equal to a predetermined threshold value, and determines an interval to be a signal other than voice when the difference value is less than the threshold value. Thereby, it becomes possible to extract features of input audio information during executing coding processes of the input audio information.

### BACKGROUND OF THE INVENTION

The present invention relates to a device and a method for processing audio information.

1. Description of the Related Art

Recently, performance of personal computers or the like has been improved, and the Internet has been widely used. Thereby, it becomes possible to utilize multimedia information broadly. At the same time, there are increasing requests for efficient retrieval of multimedia information, efficient extraction of desired information, and so forth, which become important tasks. In particular, requests for video information and audio information are rapidly increasing accompanied by popularization of digital home appliances such as digital video cameras and digital still cameras. Such requests are supposed to increase more and more in future.

A diversity of methods for retrieving and extracting audio information has been proposed, for audio information compressed and coded by a moving picture experts group (MPEG) system and uncoded audio information, etc.

For example, in Japanese Patent Application Laid-Open No. HEI10-247093, there is disclosed an audio information classifying device for classifying uncoded audio information and audio information compressed and coded by the MPEG system into a music interval and a voice signal interval. This device, from uncoded audio information, extracts frequency data per unit of time, finds energy per unit of time using the extracted data, and determines whether each interval is a voice signal interval or a music interval. On the other hand, this device, from audio information compressed and coded by the MPEG system, decodes subband data of each frame, finds energy per unit of time using the subband data, and determines whether each interval is a voice signal interval or a music interval.

As another example, there is disclosed in Japanese Patent Application Laid-Open No. 2000-66691 an audio information classifying device classifying uncoded audio information and audio information compressed and coded by the MPEG system each into a speech signal interval, a music interval, and a noise interval. This device finds energy per unit of time by the same processes as the device disclosed in the above application. Subsequently, the device determines whether each interval is a speech signal interval, a music interval, or a noise interval by using dispersion, a degree of condensation and rarefaction, and center of gravity of the energy.

FIG. 1 is a block diagram showing a configuration of a coding processing device applying an MPEG1/Audio-layer 1 system (ISO/IEC 11172-3). The coding processing device comprises a subband dividing section 111, a scaling section 112, a bit assigning section 113, a quantizing section 114, a bit stream generating section 115, and a psychoacoustic model (psychoacoustic analyzing section) 116. The subband dividing section 111 divides an input (audio) signal X into a plurality of frequency bands. The scaling section 112 calculates a scaling factor, which indicates a multiplying power to a reference value, of each of the divided subband signals to align each dynamic range. The psychoacoustic model 116 calculates a ratio of masked sound signals at each of the subbands. The bit assigning section 113 assigns bits to each of the subbands based on an output from the psychoacoustic model 116. The quantizing section 114 quantizes an output from the bit assigning section 113. The bit stream generating section 115 adds a header and supplementary information to the output information from the quantizing section 114 to output the information as audio coded data Y.

However, in the coding processing device applying the MPEG system as shown in FIG. 1, which executes compressing and coding processes to audio information, it is impossible to extract features, such as a sound signal interval and a soundless signal interval, of the input audio information during processes for coding the input audio information.

### SUMMARY OF THE INVENTION

It is therefore an object of the present invention to provide a device and a method for processing audio information by which features in audio information can be extracted during a coding process for input audio information.

According to the present invention, for achieving the object mentioned above, there is provided an audio information processing device comprising:

a subband dividing section dividing inputted audio information including a sound signal into a plurality of frequency bands;

a scaling section calculating a scaling factor, which indicates a multiplying power to a reference value, of each subband divided by the subband dividing section into each of the frequency bands, and aligning each dynamic range; and

a coding processing section compressing and coding an output signal from the scaling section to output as coded bit stream data; further including

a feature detection processing section extracting features of the audio information on the basis of the scaling factors outputted from the scaling section.

In this case, the feature detection processing section may determine whether or not the audio information is of a voice signal interval on the basis of the scaling factors.

In addition, the feature detection processing section may determine whether or not the audio information is of a soundless signal interval on the basis of the scaling factors.

Further, the audio information processing device may include a signal level calculating section inputting thereto the scaling factor of each subband outputted from the scaling section, and calculating a signal level corresponding to the scaling factor. The feature detection processing section may extract features of the audio information on the basis of the signal levels calculated by the signal level calculating section.

Furthermore, the signal level calculating section may input thereto the scaling factors in low-frequency bands outputted from the scaling section within a predetermined period of time to calculate the signal levels. The feature detection processing section may include a calculating means and a determining means. The calculating means finds a maximum value and a minimum value of the signal levels calculated by the signal level calculating section to calculate a difference therebetween. When the difference value calculated by the calculating means is greater than or equal to a predetermined threshold value, the determining means determines that the audio information is of a voice signal interval. On the other hand, when the difference value is less than the threshold value, the determining means determines that the audio information is of a signal interval except for voice.

Moreover, the signal level calculating section may input thereto all of the scaling factors outputted from the scaling section within a predetermined period of time to calculate the signal levels. The feature detection processing section may include a determining means. When the signal levels calculated by the signal level calculating section are greater than or equal to a predetermined threshold value, the determining means determines that the audio information is of a sound signal interval. On the other hand, when the signal levels are less than the threshold value, the determining means determines that the audio information is of a soundless signal interval.

In addition, according to the present invention, there is provided an audio information processing device comprising:

a stream dividing section, after inputting thereto coded bit stream data, dividing the coded bit stream data composed of each subband divided into each frequency band into bit assigning information, a scaling factor value indicating a multiplying power to a reference value, and coded data in units of each subband; and

a decoding processing section executing a decoding process to the coded data divided by the stream dividing section in units of each subband to output as audio information; further including

a feature detection processing section extracting features of the audio information on the basis of the scaling factor values outputted from the stream dividing section.

In this case, the feature detection processing section may determine whether or not the audio information is of a voice signal interval on the basis of the scaling factor values.

In addition, the feature detection processing section may determine whether or not the audio information is of a soundless interval on the basis of the scaling factor values.

Further, the audio information processing device may include a signal level calculating section inputting thereto the scaling factor of each subband outputted from the stream dividing section to calculate a signal level. The feature detection processing section may extract features of the audio information on the basis of the signal levels calculated by the signal level calculating section.

Furthermore, the signal level calculating section may input thereto the scaling factors in low-frequency bands outputted from the stream dividing section within a predetermined period of time to calculate the signal levels. The feature detection processing section may include a calculating means and a determining means. The calculating means finds a maximum value and a minimum value of the signal levels calculated by the signal level calculating section to calculate a difference therebetween. When the difference value calculated by the calculating means is greater than or equal to a predetermined threshold value, the determining means determines that the audio information is of a voice signal interval. On the other hand, when the difference value is less than the threshold value, the determining means determines that the audio information is of a signal interval except for voice.

Moreover, the signal level calculating section may input thereto all of the scaling factors outputted from the stream dividing section within a predetermined period of time to calculate the signal levels. The feature detection processing section may include a determining means. When the signal levels calculated by the signal level calculating section are greater than or equal to a predetermined threshold value, the determining means determines that the audio information is of a sound signal interval. On the other hand, when the signal levels are less than the threshold value, the determining means determines that the audio information is of a soundless signal interval.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a configuration of a coding device applying an MPEG/Audio-layer 1 coding system;

FIG. 2 is a block diagram showing a configuration of a coding device of an MPEG/Audio-layer 1 coding system to which the present invention is applied;

FIG. 3 is a block diagram showing a configuration of a decoding device decoding audio bit stream coded by the MPEG/Audio layer-1 coding system;

FIG. 4 is a flowchart showing operation in the case of executing voice detection by the devices shown in FIGS. 2 and 3;

FIG. 5 is a flowchart showing operation in the case of detecting a soundless (non-sound) interval by the devices shown in FIGS. 2 and 3; and

FIG. 6 is a diagram showing a format of an audio bit stream coded by the MPEG/Audio layer-1 coding system.

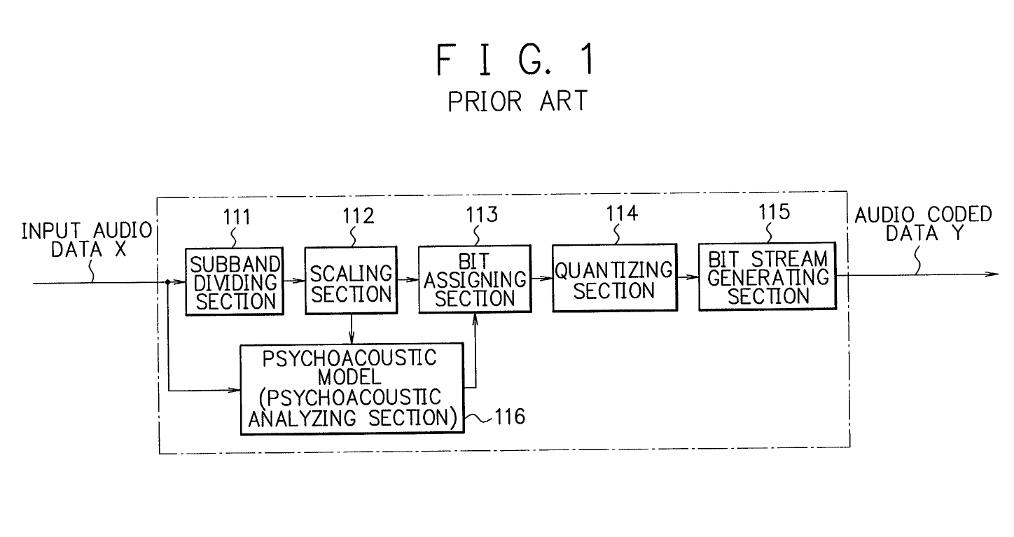

### DESCRIPTION OF THE PREFERRED EMBODIMENTS

Referring now to the drawings, embodiments of the present invention are explained in detail.

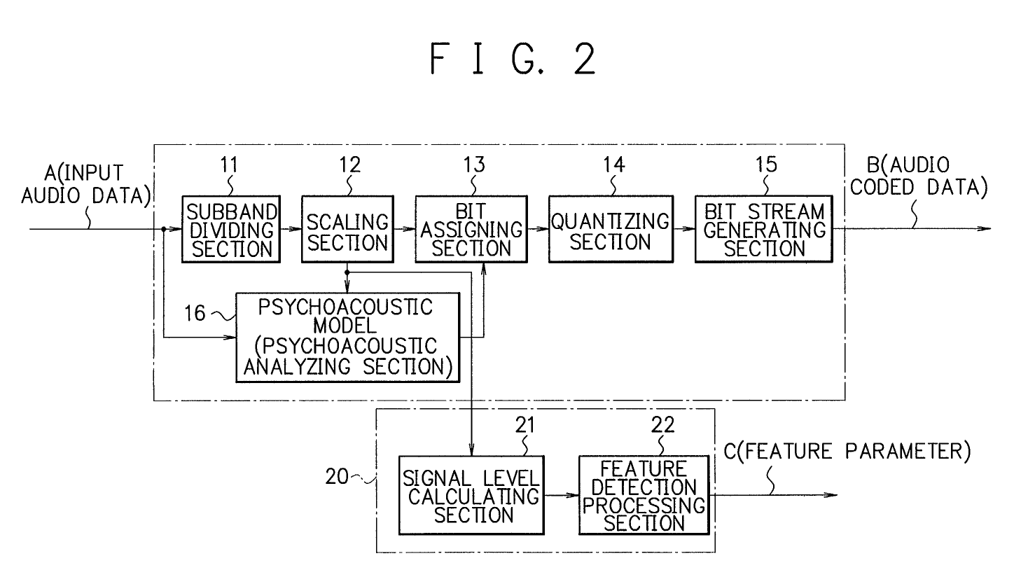

FIG. 2 is a diagram showing a configuration of a coding processing device of an MPEG1/Audio-layer 1 system (ISO/IEC 11172-3) to which the present invention is applied. As shown in FIG. 2, this coding processing device comprises a subband dividing section 11, a scaling section 12, a psychoacoustic model (psychoacoustic analyzing section) 16, a bit assigning section 13, a quantizing section 14, a bit stream generating section 15, and a sound information extracting section 20. The subband dividing section 11 divides an input signal (input audio data) A into a plurality of frequency bands. The scaling section 12 calculates a scaling factor, which indicates a multiplying power to a reference value, of each of the subband signals divided into the diverse frequency bands to align each dynamic range. The psychoacoustic model 16 finds a ratio of masked sound (including voice) signals at each of the subbands based on the input signal A and an output from the scaling section 12. The bit assigning section 13 assigns bits to each of the subbands received from the scaling section 12 based on an output from the psychoacoustic model 16. The quantizing section 14 quantizes an output from the bit assigning section 13. The bit stream generating section 15 adds a header and supplementary information to the data quantized by the quantizing section 14 to form a bit stream that is to be outputted as audio coded data B. The sound information extracting section 20 extracts sound information on the basis of the scaling factor value(s) acquired at the scaling section 12.

The sound information extracting section 20 comprises a signal level calculating section 21 and a feature detection processing section 22. The signal level calculating section 21 calculates a signal level in units of each subband using the scaling factor value thereof. The feature detection processing section 22 executes analyzing processes to the input signal A, for example, detection of a soundless interval and detection of sound (voice) on the basis of the signal level(s) calculated by the signal level calculating section 21.

In order to extract features of the input signal A, the feature detection processing section 22 executes analyzing processes to the input signal, for example, by:

a first method of comparing, by a threshold value, difference between a maximum value and a minimum value of signal levels in a predetermined time length;

a second method of determining whether or not all of the signal levels in a predetermined time length are below the threshold value;

a third method of comparing an absolute value of a calculated signal level with its threshold value;

a fourth method of determining a variation of a result acquired by calculating, through a record of past signal levels, the absolute value, the average value or the distribution of amplitude or the like; or

a fifth method of comparing a ratio of a signal level of each subband with each other.

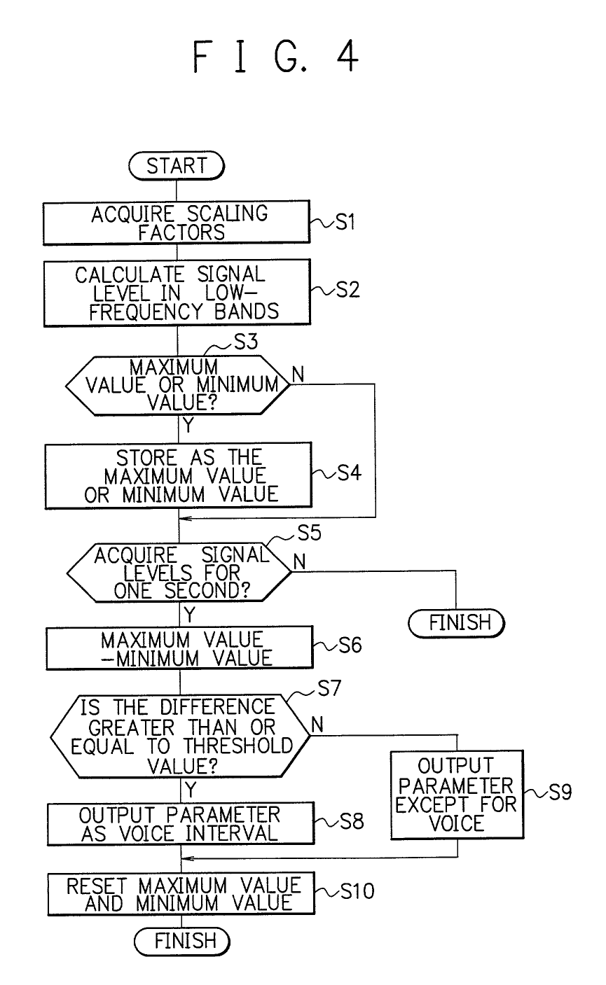

Next, a description will be given of a first embodiment of the present invention using a diagram of FIG. 2 and a flowchart of FIG. 4. In this embodiment, an explanation will be given of a case of voice detection using MPEG1/Audio-layer 1 as an example.

The subband dividing section 11 divides the input signal A quantized uniformly into 16 bits into subband signals of 32 bands. Then, 12 samples are extracted from each of the subbands. The following processes are executed in units of total 384 (32×12) samples. In order to align a dynamic range of each of the subband signals divided into 32 bands, the scaling section 12 normalizes maximum amplitude (reference value) into 1.0. Subsequently, the scaling section 12 calculates a scaling factor value indicating the multiplying power in units of each of the subbands.

The scaling factor value to be calculated indicates a ratio of an actual signal to the maximum amplitude 1.0, by which it is possible to recognize that the larger the value is, the larger amplitude a signal has in units of each of the subbands. The scaling factor obtained at the scaling section 12 is given to the psychoacoustic model 16 and the bit assigning section 13 to carry on coding processes. In addition, the scaling factor is given to the sound information extracting section 20 to be used for extracting processes of sound information (including voice information and audio information).

In this case, the signal level calculating section 21 in the sound information extracting section 20 obtains a scaling factor of each of the subbands from the scaling section 12 (Step S1). Subsequently, the signal level calculating section 21 acquires one or more scaling factors on the side of low-frequency bands from among the acquired scaling factors to calculate a signal level(s) in the low-frequency bands (Step S2). This is because a frequency band of a voice signal is narrow and is concentrated in the low-frequency bands. As an example of a way to calculate the signal level, an expression for calculating a signal level per subband is disclosed in ISO/IEC 11172-3, which is a written standard of MPEG/Audio.

In the standard, assuming that Lsb denotes a sound pressure level of each of the subbands, the calculating expression to the signal level is as follows:

Lsb(n)=20×log(Scfmax(n)×32768)−10 (1)

Incidentally, “n” denotes a subband number, and “Scfmax(n)” denotes a scaling factor value of each of the subbands. In this embodiment, expression (1) is adopted. However, the calculation is not restricted to the above expression.

The signal level(s) in the low-frequency band calculated by the signal level calculating section 21 is given to the feature detection processing section 22. The feature detection processing section 22 determines whether the signal level obtained at this time indicates a maximum value or a minimum value of signal levels having been acquired (Step S3). When the signal level is determined to be the maximum or minimum value (Y in Step S3), the feature detection processing section 22 stores the signal level as a new maximum or minimum value (Step S4). When the signal level is not determined to be the maximum or minimum value (N in Step S3), the signal level acquired at this time is not stored.

Next, the feature detection processing section 22 determines whether or not a signal level(s) for one second is checked (Step S5). In this embodiment, voice is to be detected per second. Incidentally, in MPEG/Audio layer-1, if a sampling frequency is 44.1 kHz, it takes 8.7 milliseconds to process 384 samples. When a signal level(s) for one second is checked (Y in Step S5), the feature detection processing section 22 calculates a difference between the maximum value and the minimum value of signal levels having been stored therein up to the present (Step 6).

Then, when the difference value is greater than or equal to a predetermined threshold value (Y in Step S7), the feature detection processing section 22 regards this one second as a voice signal interval, and outputs parameter C as a voice signal interval (Step S8). Otherwise (N in Step S7), the feature detection processing section 22 regards this one second as a signal interval other than voice such as music, and outputs parameter C as a signal interval other than voice (Step S9). After the parameter is outputted, the maximum value and the minimum value of the stored signal level(s) at the present moment are reset (Step S10). Subsequently, the next one second is detected. Incidentally, when a signal level(s) for one second is not checked (N in Step S5), scaling factor values of the next 384 samples are acquired and processed as with the above case.

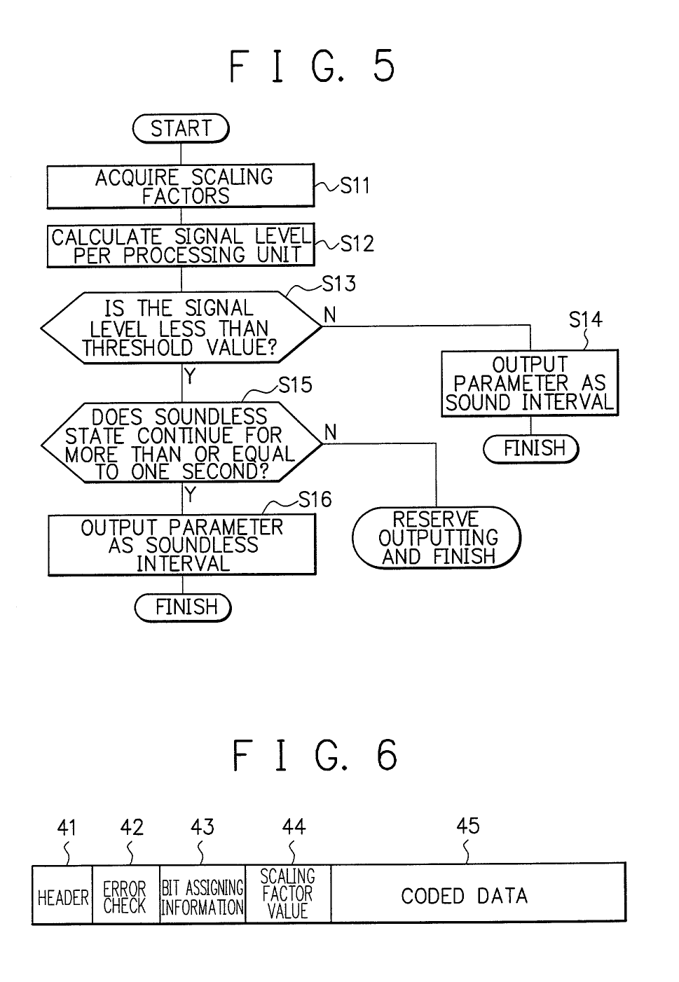

Next, a description will be given of a second embodiment of the present invention using a block diagram shown in FIG. 2 and a flowchart shown in FIG. 5.

In the first embodiment, the sound information extracting section 20 detects a voice signal interval. On the other hand, in this embodiment, the sound information extracting section 20 detects a soundless signal interval.

An input signal A quantized uniformly into 16 bits is divided into subband signals of 32 bands at the subband dividing section 11 shown in FIG. 2 as with the first embodiment. In order to align a dynamic range of each of the subband signals divided into 32 bands, the scaling section 12 normalizes maximum amplitude (reference value) into 1.0. Subsequently, the scaling section 12 calculates a scaling factor value indicating the multiplying power to the reference value for each of the subbands. As with the first embodiment, the scaling factor acquired at the scaling section 12 is given to the psychoacoustic model 16 and the bit assigning section 13 to carry on coding processes. In addition, the scaling factor is also given to the sound information extracting section 20 to be used for extracting processes of sound (voice) information.

In this case, the signal level calculating section 21 in the sound information extracting section 20 obtains a scaling factor of each of the subbands from the scaling section 12 (Step S11). Subsequently, the signal level calculating section 21 calculates signal levels per 384 samples using all of the acquired scaling factor values (Step S12). Incidentally, the above described expression (1) may be used to calculate the signal level. However, the calculation is not restricted to the expression.

Next, the feature detection processing section 22 determines whether or not the signal levels per 384 samples acquired at the signal level calculating section 21 are less than a predetermined threshold value (Step S13). When the signal level is more than or equal to the predetermined threshold value (N in Step S13), the feature detection processing section 22 regards the interval as a sound signal interval, and outputs parameter C as a sound signal interval (Step S14). Subsequently, scaling factor values of the next 384 samples are acquired to be processed.

On the other hand, when the signal levels are less than the predetermined threshold value (Y in Step S13), the feature detection processing section 22 determines whether or not the state where the signal levels are less than the threshold value continues for one or more seconds (Step S15). When the state continues for one or more seconds (Y in Step S15), the feature detection processing section 22 regards the interval as a soundless signal interval, and outputs parameter C as a soundless signal interval (Step S16). Subsequently, scaling factors of the next 384 samples are acquired to be processed. Incidentally, when the state does not continue for one or more seconds (N in step S15), scaling factor values of the next 384 samples are acquired to be processed.

As described above, in the first and second embodiments, the sound information (including voice information, and audio information) detecting processes are executed using the scaling factor values of the parameter calculated through the sound coding processes of the MPEG system. Thereby, processes for extracting dedicated parameter specially used to extract the sound information can be eliminated, and it is possible to execute the processes with light burden. Accordingly, even in the case of real-time coding operation, the sound information can be extracted simultaneously.

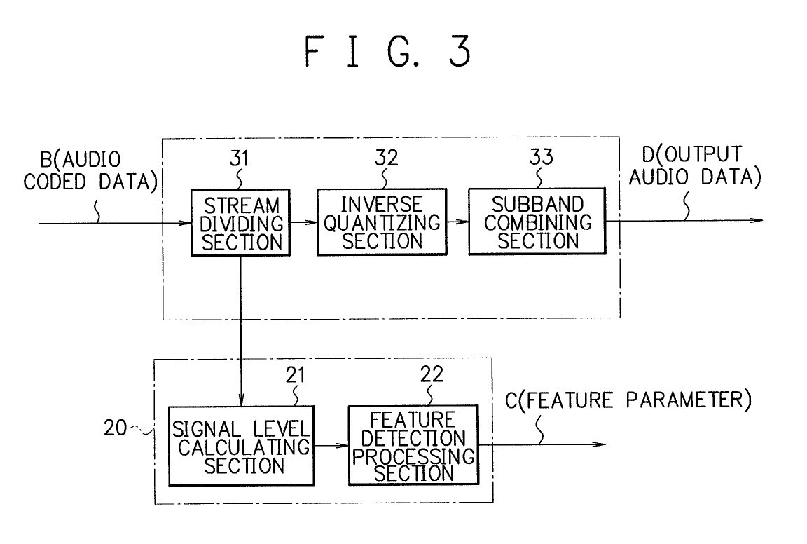

FIG. 3 is a diagram showing a decoding device to which the present invention is applied, and showing a configuration for executing feature extraction of data coded by MPEG system. In FIG. 3, the decoding device comprises a bit stream dividing section (hereinafter referred to as a stream dividing section) 31, an inverse quantizing section 32, a subband combining section 33, and the sound information extracting section 20 including the signal level calculating section 21 and the feature detection processing section 22. The stream dividing section 31 divides input coded data B into bit assigning information, a scaling factor value, and coded data per subband. An inverse quantizing section 32 decodes the data divided at the stream dividing section 31 in units of each of the subbands. The subband combining section 33 combines each of the subbands decoded at the inverse quantizing section 32 to output the subbands as sound data D. The sound information extracting section 20 extracts sound (including voice) information on the basis of the scaling factor values divided at the stream dividing section 31.

Next, a description will be given of a third embodiment of the present invention using a block diagram shown in FIG. 3, flowcharts shown in FIGS. 4 and 5, and a data format shown in FIG. 6. In the first and second embodiments, the processes by the sound information extracting section 20 are executed during coding processes. However, in this embodiment, there will be explained a case where the sound information extracting section 20 extracts sound information from an audio bit stream coded by MPEG system.

First, sound decoding processes by the MPEG system will be explained. In this embodiment, MPEG/Audio layer-1 is taken as an example. A bit stream coded by the MPEG system has a data format to which a header 41, error check information 42, bit assigning information 43, a scaling factor value 44, and coded data 45 are assigned in this order from the head. When receiving such a bit stream, the stream dividing section 31 divides the bit stream into the bit assigning information, a scaling factor value, and coded data per subband. Subsequently, after the inverse quantizing section 32 executes a decode process in units of each of the subbands, the subband combining section 33 combines each of the subbands to output as a sound signal.

By the way, conventionally, a method to use a sound signal outputted from the subband combining section 33 or information decoded at the inverse quantizing section 32 in units of each of the subbands has been adopted to extract sound information. However, in this embodiment, firstly, the stream dividing section 31 divides a bit stream, and gives a scaling factor value acquired at this process to the sound information 20 as it is. Thereafter, the signal level calculating section 21 and the feature detection processing section 22 in the sound information extracting section 20 executes sound information extracting processes, which are the same as that in the first and second embodiments.

Namely, after a scaling factor value(s) in the low-frequency bands is inputted from the stream dividing section 31, the signal level calculating section 21 calculates a signal level. Then, the feature detection processing section 22 finds a maximum value and a minimum value of the signal levels calculated at the signal level calculating section 21 to calculate a difference therebetween. When the difference value is greater than or equal to a predetermined threshold value, the coded data B is regarded as a voice signal. On the other hand, the difference value is less than the threshold value, the coded data B is regarded as a signal other than voice (processes corresponding to the first embodiment).

Furthermore, the signal level calculating section 21 inputs all of the scaling factor values from the stream dividing section 31 to calculate the signal levels thereof. When the feature detection processing section 22 determines that the signal levels calculated at the signal level calculating section 21 are greater than or equal to a predetermined threshold value, the coded data B is regarded as a sound signal. Otherwise, the coded data B is regarded as a soundless signal (processes corresponding to the second embodiment).

By this means, when sound information is extracted from a bit stream compressed and coded by the MPEG system, the scaling factor value in the bit stream is used as a parameter. Thereby, processes of extracting sound information can be executed without processes of decoding the bit stream. Therefore, it is possible to extract sound information with light burden, and further, to process sound information at high speed even by using a personal computer with a poor performance.

As explained above, the present invention provides an audio information extracting method with high efficiency in which processing burden during audio information compressing and coding processes can be reduced. Further, according to the present invention, it is possible to extract, only by the processes of analyzing bit stream, audio information even from data coded by the MPEG system.

Incidentally, in the above described first to third embodiments, MPEG/Audio layer-1 is taken as an example. However, it is also possible to apply the present invention to another sound coding system having a means for calculating scaling factor values using a coding system by a subband division, such as MPEG/Audio layer-2 and MPEG/Audio layer-3.

Furthermore, the feature detection processing section 22 in the sound information extracting section 20 executes analyzing processes of an inputted signal by a method of comparing a difference between a maximum value and a minimum value of signal levels in a predetermined time interval with a threshold value as described in the first embodiment, and a method of determining whether or not all of the signal levels in a predetermined time interval is below a threshold value as described in the second embodiment. However, it is also possible to apply other methods, such as a method of comparing an absolute value of a signal level with a threshold value, and a method of finding, from a past signal level record, an absolute value, and an average value or distribution of amplitude of the signal levels to make a determination by using the variation of the acquired results.

As set forth hereinbefore, according to the present invention, there is provided an audio information processing device comprising a subband dividing section dividing an inputted audio information including sound (voice) signal into a plurality of frequency bands, a scaling section calculating a scaling factor, which indicates a multiplying power to a reference value, of each of the subband signals divided into the diverse frequency bands to align each dynamic range, and a coding processing section compressing and coding the output signal from the scaling section to output the signal as coded bit stream data, wherein features of the audio information are extracted on the basis of the scaling factor of each of the subbands outputted from the scaling section. Thereby, it is possible to extract features of the audio information in the middle of coding the inputted audio information simultaneously. Further, sound information (audio information) feature extracting processes are executed using a scaling factor value of a parameter calculated in sound coding processes by the MPEG system. Thereby, the processes to extract a dedicated parameter specially used in the sound information extracting processes can be eliminated, and therefore, the processes can be executed with light burden. Even in the case of executing sound coding processes in real time, sound information can be extracted simultaneously.

Furthermore, when coded bit stream data is inputted, in an audio information processing device comprising a stream dividing section dividing the coded bit stream data composed of each of the subbands divided into each of the frequency bands into bit assigning information, a scaling factor value indicating a multiplying power to a reference value, and coded data, and a decoding processing section decoding the coded data divided at the stream dividing section in units of each of the subbands to output the data as audio information, features of the audio information are extracted on the basis of the scaling factor value of each of the subbands outputted from the stream dividing section. Thereby, sound information can be extracted without decoding the coded bit stream. Therefore, it is possible to extract sound information with light burden, and thereby, high-speed processing can be expected even in the case of using a personal computer with a poor performance.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An audio information processing device comprising:
a subband dividing section dividing inputted audio information including a sound signal into a plurality of frequency bands;
a scaling section calculating a scaling factor, which indicates a multiplying power to a reference value, of each subband divided by the subband dividing section into each of the frequency bands, and aligning each dynamic range; and
a coding processing section compressing and coding an output signal from the scaling section by using a MPEG system to output as coded bit stream data; further including
a feature detection processing section extracting features of the audio information on the basis of the scaling factors outputted from the scaling section.

2. The audio information processing device as claimed in claimed 1, wherein the feature detection processing section includes a means of determining whether or not the audio information is of a voice signal interval on the basis of the scaling factors.

3. The audio information processing device as claimed in claim 1, wherein the feature detection processing section includes a means of determining whether or not the audio information is of a soundless signal interval on the basis of the scaling factors.

4. An audio information processing device comprising:
a subband dividing section dividing inputted audio information including a sound signal into a plurality of frequency bands;
a scaling section calculating a scaling factor, which indicates a multiplying power to a reference value, of each subband divided by the subband dividing section into each of the frequency bands, and aligning each dynamic range; and
a coding processing section compressing and coding an output signal from the scaling section by using a MPEG system to output as coded bit stream data; further including:
a feature detection processing section extracting features of the audio information on the basis of the scaling factors outputted from the scaling section; and
a signal level calculating section inputting thereto the scaling factor of each subband outputted from the scaling section, and calculating a signal level corresponding to the scaling factor; wherein the feature detection processing section extracts features of the audio information on the basis of the signal levels calculated by the signal level calculating section.

5. The audio information processing device as claimed in claim 4, wherein:
the signal level calculating section inputs thereto the scaling factors in low-frequency bands outputted from the scaling section within a predetermined period of time to calculate the signal levels; and
the feature detection processing section comprises:
a calculating means of finding a maximum value and a minimum value of the signal levels calculated by the signal level calculating section, and calculating a difference between the maximum value and the minimum value; and
a determining means of, when the difference value calculated by the calculating means is greater than or equal to a predetermined threshold value, determining that the audio information is of a voice signal interval, on the other hand, when the difference value is less than the threshold value, determining that the audio information is of a signal interval except for voice.

6. The audio information processing device as claimed in claim 4, wherein:
the signal level calculating section inputs thereto all of the scaling factors outputted from the scaling section within a predetermined period of time to calculate the signal levels; and
the feature detection processing section includes a determining means of, when the signal levels calculated by the signal level calculating section are greater than or equal to a predetermined threshold value, determining that the audio information is of a sound signal interval, on the other hand, when the signal levels are less than the threshold value, determining that the audio information is of a soundless signal interval.

7. An audio information processing device comprising:
a stream dividing section, after inputting thereto bit stream data coded by a MPEG system, dividing the coded bit stream data composed of each subband divided into each frequency band into bit assigning information, a scaling factor value indicating a multiplying power to a reference value, and coded data in units of each subband; and
a decoding processing section executing a decoding process to the coded data divided by the stream dividing section in units of each subband to output as audio information; further including
a feature detection processing section extracting features of the audio information on the basis of the scaling factor values outputted from the stream dividing section.

8. The audio information processing device as claimed in claim 7, wherein the feature detection processing section includes a means of determining whether or not the audio information is of a voice signal interval on the basis of the scaling factor values.

9. The audio information processing device as claimed in claim 7, wherein the feature detection processing section includes a means of determining whether or not the audio information is of a soundless interval on the basis of the scaling factor values.

10. An audio information processing device comprising:
a stream dividing section, after inputting thereto bit stream data coded by a MPEG system, dividing the coded bit stream data composed of each subband divided into each frequency band into bit assigning information, scaling factor value indicating a multiplying power to a reference value, and coded data in units of each subband; and
a decoding processing section executing a decoding process to the coded data divided by the stream dividing section in units of each subband to output as audio information; further including:
a feature detection processing section extracting features of the audio information on the basis of the scaling factor values outputted from the stream dividing section; and
a signal level calculating section inputting thereto the scaling factor of each subband outputted from the stream dividing section to calculate a signal level; wherein
the feature detection processing section extracts features of the audio information on the basis of the signal levels calculated by the signal level calculating section.

11. The audio information processing device as claimed in claim 10, wherein:
the signal level calculating section inputs thereto the scaling factors in low-frequency bands outputted from the stream dividing section within a predetermined period of time to calculate the signal levels; and
the feature detection processing section comprises:
a calculating means of finding a maximum value and a minimum value of the signal levels calculated by the signal level calculating section, and calculating a difference between the maximum value and the minimum value; and
a determining means of, when the difference value calculated by the calculating means is greater than or equal to a predetermined threshold value, determining that the audio information is of a voice signal interval, on the other hand, when the difference value is less than the threshold value, determining that the audio information is of a signal interval except for voice.

12. The audio information processing device as claimed in claim 10, wherein:
the signal level calculating section inputs thereto all of the scaling factors outputted from the stream dividing section within a predetermined period of time to calculate the signal levels; and
the feature detection processing section includes a determining means of, when the signal levels calculated by the signal level calculating section are greater than or equal to a predetermined threshold value, determining that the audio information is of a sound signal interval, on the other hand, when the signal levels are less than the threshold value, determining that the audio information is of a soundless signal interval.

13. An audio information processing method, in an audio information processing device comprising:
a subband dividing section dividing inputted audio information including a sound signal into a plurality of frequency bands;
a scaling section calculating a scaling factor, which indicates a multiplying power to a reference value, of each subband divided by the subband dividing section into each of the frequency bands, and aligning each dynamic range; and
a coding processing section compressing and coding an output signal from the scaling section by using a MPEG system to output as coded bit stream data; including
a first step of extracting features of the audio information on the basis of the scaling factors outputted from the scaling section.

14. The audio information processing method as claimed in claim 13, wherein the first step further includes a second step of determining whether or not the audio information is of a voice signal interval on the basis of the scaling factors.

15. The audio information processing method as claimed in claim 13, wherein the first step further includes a third step of determining whether or not the audio information is of a soundless signal interval on the basis of the scaling factors.

16. An audio information processing method, in an audio information processing device comprising:
a subband dividing section dividing inputted audio information including a sound signal into a plurality of frequency bands;
a scaling section calculating a scaling factor, which indicates a multiplying power to a reference value, of each subband divided by the subband dividing section into each of the frequency bands, and aligning each dynamic range; and
a coding processing section compressing and coding an output signal from the scaling section by using a MPEG system to output as coded bit stream data; including:
a first step of extracting features of the audio information on the basis of the scaling factors outputted from the scaling section; and
a fourth step of inputting the scaling factor of each subband outputted from the scaling section, and calculating a signal level corresponding to the scaling factor; wherein
the first step further includes a fifth step of extracting features of the audio information on the basis of the signal levels calculated in the fourth step.

17. The audio information processing method as claimed in claim 16, wherein:
the fourth step further includes a sixth step of inputting the scaling factors in low-frequency bands outputted from the scaling section within a predetermined period of time to calculate the signal levels; and
the fifth step further includes:
a seventh step of finding a maximum value and a minimum value of the signal levels calculated at the sixth step, and calculating a difference between the maximum value and the minimum value; and
an eighth step of, when the difference value calculated at the seventh step is greater than or equal to a predetermined threshold value, determining that the audio information is of a voice signal interval, on the other hand, when the difference value is less than the threshold value, determining that the audio information is of a signal interval except for voice.

18. The audio information processing method as claimed in claim 16, wherein:
the fourth step further includes a ninth step of inputting all of the scaling factors outputted from the scaling section within a predetermined period of time to calculate the signal levels; and
the fifth step further includes a tenth step of, when the signal levels calculated at the ninth step are greater than or equal to a predetermined threshold value, determining that the audio information is of a sound signal interval, on the other hand, when the signal levels are less than the threshold value, determining that the audio information is of a soundless signal interval.

19. An audio information processing method, in an audio information processing device comprising:
a stream dividing section, after inputting thereto bit stream data coded by a MPEG system, dividing the coded bit stream data composed of each subband divided into each frequency band into bit assigning information, a scaling factor value indicating a multiplying power to a reference value, and coded data in units of each subband; and
a decoding processing section executing a decoding process to the coded data divided by the stream dividing section in units of each subband to output as audio information; including
an eleventh step of extracting features of the audio information on the basis of the scaling factor values outputted from the stream dividing section.

20. The audio information processing method as clamed in claim 19, wherein the eleventh step further includes a twelfth step of determining whether or not the audio information is of a voice signal interval on the basis of the scaling factor values.

21. The audio information processing method as claimed in claim 19, wherein the eleventh step further includes a thirteenth step of determining whether or not the audio information is of a soundless interval on the basis of the scaling factor values.

22. An audio information processing method, in an audio information processing device comprising:
a stream dividing section, after inputting thereto bit stream data coded by a MPEG system, dividing the coded bit stream data composed of each subband divided into each frequency band into bit assigning information, a scaling factor value indicating a multiplying power to a reference value, and coded data in units of each subband; and
a decoding processing section executing a decoding process to the coded data divided by the stream dividing section in units of each subband to output as audio information; including:
an eleventh step of extracting features of the audio information on the basis of the scaling factor values outputted from the stream dividing section; and
a fourteenth step of inputting the scaling factor of each subband outputted from the stream dividing section to calculate a signal level; wherein
the eleventh step further includes a fifteenth step of extracting features of the audio information on the basis of the signal levels calculated by the fourteenth step.

23. The audio information processing method as claimed in claim 22, wherein:
the fourteenth step further includes a sixteenth step of inputting the scaling factors in low-frequency bands outputted from the stream dividing section within a predetermined period of time to calculate the signal levels; and
the fifteenth step further includes:
a seventeenth step of finding a maximum value and a minimum value of the signal levels calculated at the sixteenth step, and calculating a difference between the maximum value and the minimum value; and
an eighteenth step of, when the difference value calculated at the seventeenth step is greater than or equal to a predetermined threshold value, determining that the audio information is of a voice signal interval, on the other hand, when the difference value is less than the threshold value, determining that the audio information is of a signal interval except for voice.

24. The audio information processing method as claimed in claim 22, wherein:
the fourteenth step further includes a nineteenth step of inputting all of the scaling factors outputted from the stream dividing section within a predetermined period of time to calculate the signal levels; and
the fifteenth step further includes a twentieth step of, when the signal levels calculated at the nineteenth step are greater than or equal to a predetermined threshold value, determining that the audio information is of a sound signal interval, on the other hand, when the signal levels are less than the threshold value, determining that the audio information is of a soundless signal interval.
